(19) United States
(12) Patent Application Publication
(10) Pub. No.: US 2009/0220104 A1
(43) Pub. Date: Sep. 3, 2009

(54) Venue private network

(75) Inventor: Robert G. Allison, Corona Del Mar, CA (US)

Correspondence Address: PATENT LAW OFFICE OF DAVID G. BECK, P. O. BOX 1146, MILL VALLEY, CA, 94942, US

(73) Assignee: Ultimate Ears, LLC, Irvine, CA (US)

(21) Appl. No.: 12/074,319

(22) Filed: Mar. 3, 2008

(51) Int. Cl. H04B 3/00

(52) U.S. Cl. 381/77

(57) ABSTRACT

A method and apparatus for supplying participating attendees within a specific venue an improved acoustical experience is provided. To implement the system the venue (100) is divided into multiple zones, each zone preferably including a plurality of attendee seats. Using a receiver (205-208) configured to wirelessly receive audio programming from a transmitter (203) coupled to a central processor (202) and a sound system (201), each participating attendee is able to listen to zone specific audio programming through a set of audio monitors (209).

### FIELD OF THE INVENTION

The present invention relates generally to audio monitoring systems and, more particularly, to a method and apparatus for providing users with an enhanced listening experience in a variety of different settings.

### BACKGROUND OF THE INVENTION

People attend a variety of different types of events (e.g., rock concerts, symphonies, plays, etc.) in a variety of different settings, many of which provide less than optimal listening conditions. In some situations, the listening conditions are adversely affected by the size of the venue. This is often the case for concerts held at large stadiums, many of which are designed for other purposes (e.g., football, baseball, basketball, etc.) and therefore may not be designed to achieve optimal sound quality. Additionally, the sheer size of such venues often result in sub-optimal acoustic conditions as it is virtually impossible to optimize the acoustics both for listeners seated close to the performers and those seated at a great distance from the performers. In other situations, the setting itself may contribute to the poor sound quality experienced by the listener. For example, a concert held in a park is unlikely to offer the listener the same musical experience as a concert held in a symphony hall since the latter provides carefully controlled acoustics which cannot be achieved in an outdoor setting.

Event attendees who experience poor acoustics will often leave the event feeling disappointed, that feeling being directed at the event, the artist performing at the event, the venue, or with all three. For an artist, disappointing the attendees of even a single concert will often lead to bad publicity which, in turn, will often lead to lower music sales, decreased attendance at future concerts, and a shrinking fan base. For the venue, dissatisfied attendees and the bad publicity that accompanies such an event will often translate to lower ticket sales, both because of an inability to sell as many tickets for future events as well as the need to charge less per ticket in order to overcome the image of a venue offering inferior sound quality.

In addition to the desire to maintain their fan base, artists often look for ways to provide their fans with an improved or otherwise novel experience. For example, even very well known artists with huge fan bases will occasionally play concerts at small, intimate venues, often with little pre-concert publicity. Although such venues help the artist to connect with their fans, since it provides an intimate experience for very few fans the artist is often left searching for ways of achieving the same experience with more fans. The present invention provides such an experience while overcoming the problems associated with many venues.

### SUMMARY OF THE INVENTION

The present invention provides a method and apparatus for supplying participating attendees within a specific venue an improved acoustical experience. To implement the invention the venue is divided into multiple zones, each zone preferably including a plurality of attendee seats. Using a receiver configured to wirelessly receive audio programming from a transmitter coupled to a central processor and a sound system and then transmit zone specific audio programming through a set of audio monitors, each participating attendee is able to listen to an improved version of the live event.

In one embodiment of the invention, a method of supplying audio programming via audio monitors to participating attendees of a live event is provided, the method comprising the steps of dividing the venue into multiple zones, assigning each participating attendee to a particular zone of the multiple zones, wirelessly transmitting the audio programming within the venue, providing each participating attendee with a receiver for wirelessly receiving the audio programming and transmitting zone specific audio programming to the attendee via audio monitors, and then retrieving the receiver from the attendee at the conclusion of the live event. In addition to primary program material, the audio programming can include secondary program material. The receiver can provide means for selecting the program material to be provided as the zone specific audio programming. In one configuration, the step of wirelessly transmitting the audio programming is further comprised of the step of wirelessly transmitting a plurality of zone specific audio programming within the venue, the receiver determining which zone specific audio programming corresponds to the particular zone assigned to the participating attendee. In another configuration, the step of wirelessly transmitting the audio programming is further comprised of the step of wirelessly transmitting a plurality of zone specific audio programming within the venue, the receiver providing means for selecting which zone specific audio programming corresponds to the particular zone assigned to the participating attendee. In another configuration, the receiver performs the step of modifying the audio program to generate the zone specific audio programming corresponding to the particular zone assigned to the participating attendee.

In another embodiment of the invention, a method of supplying audio programming via audio monitors to participating attendees of a live event is provided, the method comprising the steps of dividing the venue into multiple zones, wirelessly transmitting the audio programming within the venue, providing each participating attendee with a receiver for determining a receiver location relative to a primary venue location using GPS and wirelessly receiving the audio programming and transmitting zone specific audio programming to the attendee via audio monitors, and then retrieving the receiver from the attendee at the conclusion of the live event. In addition to primary program material, the audio programming can include secondary program material. The receiver can provide means for selecting the program material to be provided as the zone specific audio programming. In one configuration, the step of wirelessly transmitting the audio programming is further comprised of the step of wirelessly transmitting a plurality of zone specific audio programming within the venue, the receiver determining which zone specific audio programming corresponds to the particular zone assigned to the receiver's location. In another configuration, the receiver performs the step of modifying the audio program to generate the zone specific audio programming corresponding to the particular zone assigned to the receiver's location.

In yet another embodiment of the invention, a venue network system is provided comprised of a central processor that receives an audio mix of a live event within a specific venue, the venue divided into multiple zones, a central transmitter that wirelessly transmits an audio program comprised of at least a portion of the audio mix, and a plurality of receivers each of which is configured for a particular zone of the multiple zones and configured to receive the audio program, process the audio program to generate a zone specific audio program and transmit the zone specific audio program through a pair of audio monitors. In one configuration, each receiver is further comprised of a global positioning system, the receiver using receiver location information provided by the global positioning system to determine the particular zone for which the receiver is configured. In another configuration, each receiver is further comprised of a zone selector. The receiver can be configured to further comprise a volume controller, at least one sound controller and/or means for transmitting information back to the central processor.

In yet another embodiment of the invention, a venue network system is provided comprised of a central processor that receives an audio mix of a live event within a specific venue, the venue divided into multiple zones, a central transmitter that wirelessly transmits a plurality of zone specific audio programs each of which is comprised of at least a portion of the audio mix, and a plurality of receivers each of which is configured for a particular zone of the multiple zones and configured to receive the zone specific audio program corresponding to the receiver's particular zone and transmit the zone specific audio program through a pair of audio monitors. The receiver can be configured to further comprise a volume controller, at least one sound controller and/or means for transmitting information back to the central processor.

A further understanding of the nature and advantages of the present invention may be realized by reference to the remaining portions of the specification and the drawings.

### BRIEF DESCRIPTION OF THE DRAWINGS

FIG. 1 is an illustration of a concert arena divided into zones;

FIG. 2 schematically illustrates one configuration of the invention;

FIG. 3 illustrates one configuration of a receiver for use with the invention;

FIG. 4 schematically illustrates an alternate configuration of the invention;

FIG. 5 illustrates one configuration of a transceiver; and

FIG. 6 illustrates an alternate configuration of a transceiver.

### DESCRIPTION OF THE SPECIFIC EMBODIMENTS

The system of the present invention provides an enhanced acoustic experience for participating attendees at concerts and other events (e.g., plays, sporting events, etc.). As will be described in detail, the system is scalable to different size venues and can be configured to provide any of a variety of services. In its most basic configuration, the system transmits an audio program to participating attendees throughout the venue, the exact nature of the audio program depending, at least in part, on the location of the attendee in question. The transmitted audio program can be the same as, or different from, the audio program occurring live on stage at the event.

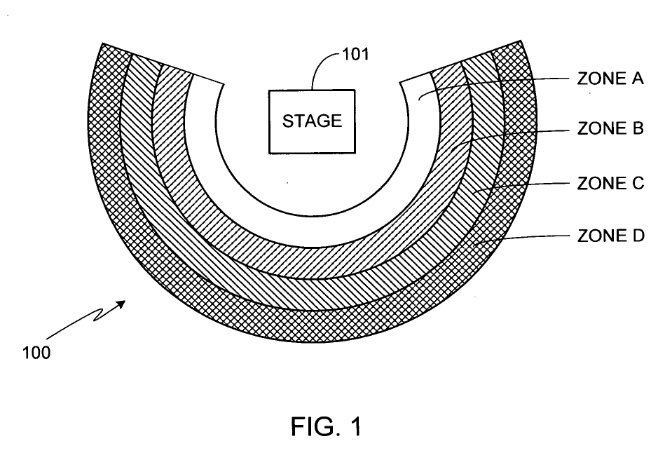

FIG. 1 is an illustration of a concert arena 100. It will be appreciated that the invention is not limited to arenas of this particular configuration, i.e., an arena in which the seats are positioned in a circular rows surrounding the stage and in which a back stage area is blocked off. Thus the invention is similarly applicable to venues in which the attendees are located on all sides of the performers or in which the seating is configured in non-circular rows. In this exemplary arena, the seats around stage 101 are divided into a plurality of zones; in this example zones A-D. Typically within each zone there are multiple rows of seats. The zones are defined by the distance from stage 101, and thus the performers, each zone including a range of distances.

To utilize the invention, the attendees within each zone that choose to gain the benefits of the system are provided with a wireless receiver. The wireless receiver can be preconfigured for a specific zone or, as described further below, configurable for a specific zone using zone selection means (e.g., zone selector switch, GPS, etc.). In a preferred embodiment of the invention, the wireless receivers are rented to the attendees for the duration of the program, thus minimizing cost to the attendees while providing a new revenue stream for the participating venue. At the conclusion of the event (e.g., concert), the participating attendees simply return the receiver to the venue operator.

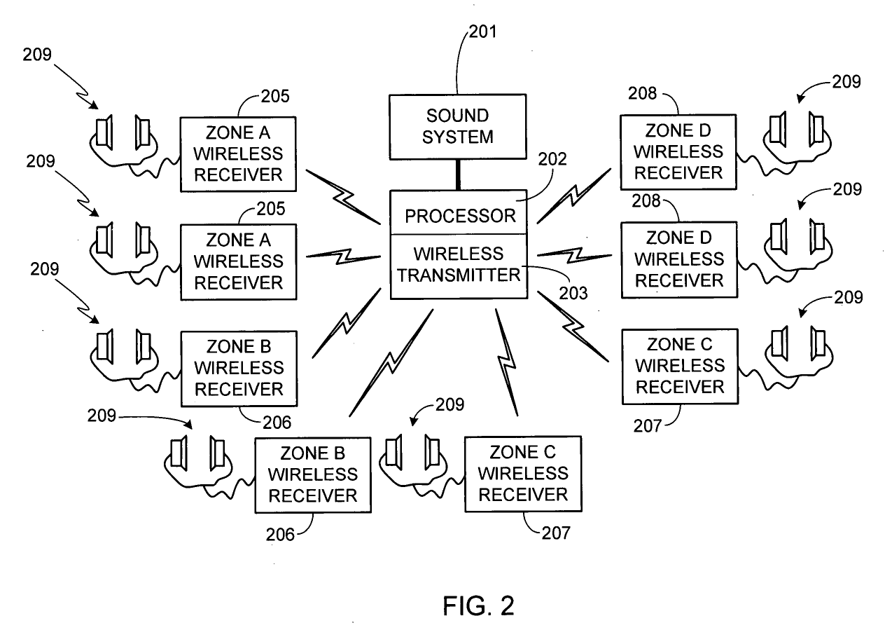

FIG. 2 schematically illustrates one configuration of the invention suitable for use with the exemplary arena of FIG. 1. As shown, an output signal preferably representing all or some portion of the audio program presented by the performer (or other source) is transmitted from sound system 201 to a sound processor 202 and wireless transmitter 203 to which it is coupled. Typically sound system 201 is a mixing board that allows the system operator or controller to determine what audio program the attendees using the system will be provided. Sound processor 202 and wireless transmitter 203, in turn, wirelessly transmits signals representing the desired audio program to a plurality of wireless receivers 205-208 that correspond to the zones of the arena. Accordingly, wireless receivers 205 correspond to zone A in FIG. 1; wireless receivers 206 correspond to zone B; wireless receivers 207 correspond to zone C; and wireless receivers 208 correspond to zone D. It will be appreciated that the configurations shown in FIGS. 1 and 2 are merely illustrative of the invention, and that both fewer and greater numbers of zones can be used in the invention and that both fewer and greater numbers of wireless receivers can be used within each zone, with the expectation that a large number of wireless receivers will be used within each zone.

Attached to each wireless receiver 205-208 is a pair of audio monitors 209. As used herein, the term ‘audio monitors’ refers to any of a variety of well known monitors including, but not limited to, ear buds, in ear monitors, over-the-head headsets, over-the-ear headsets, clip-on headsets, and behind-the-neck headsets. Audio monitors 209 can be supplied with the wireless receiver, or supplied as an option. Additionally, audio monitors 209 can be hard-wired to the wireless receiver or be removable, for example using a stereo plug. If a stereo plug is used, a conventional plug can be used (e.g., 2.5 mm or 3.5 mm plug) thus allowing the user to substitute their own audio monitors. Alternately, a proprietary plug and jack arrangement can be used, thereby preventing the user from easily substituting audio monitors.

Without the use of the present invention, the further an attendee is from the stage, the greater the delay between the audio portion of a live performance and the visual portion of the same performance due to differences in the speed of light and the speed of sound. Clearly this impacts the quality of the performance experienced by the attendee, especially for those attendees in the further reaches of the arena. With the use of the invention, however, the audio portion of a performance can be properly synchronized with the visual portion of the same performance based on the attendee's location within the venue, i.e., based on the zone in which the attendee is sitting.

A major benefit of the present invention is that it can be used to provide a dramatic improvement in the quality of the audio performance experienced by those attendees utilizing the invention. In general, regardless of where someone sits at a concert, the sound quality is less than desirable for a variety of reasons. First, very few concert halls/arenas are acoustically optimized. Second, the volume of the performance varies greatly throughout the venue, the degree of variation depending primarily upon the size of the concert hall or arena. Typically the volume near the stage will be uncomfortably loud while the volume far from the stage may be too low, especially if there is much crowd noise. Third, the sound quality of a performance will be greatly affected by extraneous noise, for example crowd noise. Lastly, audio distortion often leads to unacceptably poor sound quality at a concert. In part, audio distortion is due to the volume of the performance, especially if the volume is very high because of the size of the arena and the need to adequately reach the furthest seats. Frequency-based differences in the speed of sound will also lead to audio distortion. Additionally, as the sound travels through the arena, from the stage to the attendees, it is attenuated. As the degree of attenuation varies depending upon the frequency, audio attenuation will also lead to audio distortion, the magnitude of the distortion typically increasing as the distance from the stage to the attendee in question is increased.

Accordingly, by utilizing high fidelity audio monitors, the present invention can provide attendees with better sound quality than is typically achievable with the unaided ear. In particular, audio monitors 209, in conjunction with the wireless transmitter 203, processor 202, sound system 201, and the zone appropriate wireless receiver 205-208, can provide the user with low distortion, high quality sound regardless of where the attendee is within the arena, thereby providing a much better audio experience than is currently achievable.

Another benefit of the present invention is that it can be used to minimize, if not altogether eliminate, hearing damage that can occur at a concert. In general, if an attendee is seated too close to a speaker, they may incur hearing damage due to excessive sound pressure levels. For large concert arenas where the volume levels must be maintained at very high levels in order to reach all attendees, the region of potentially dangerous volume levels surrounding the speakers is even greater. In addition to trying to sit far away from the speakers, cautious concert attendees can also wear ear plugs. Unfortunately as solid earplugs (e.g., foam or silicon ear plugs) preferentially attenuate higher frequencies, most music fans are unwilling to wear them since they do not want to compromise the sound quality of the concert that they are attending. Through the use of the invention, however, the volume can be maintained at a safe level without compromising sound quality since the volume experienced by the user is given by the gain of the wireless receiver rather than the volume of the ambient environment. To this end, the inventor has found that in-ear monitors or closed headphones are particularly beneficial as they effectively attenuate the ambient environment.

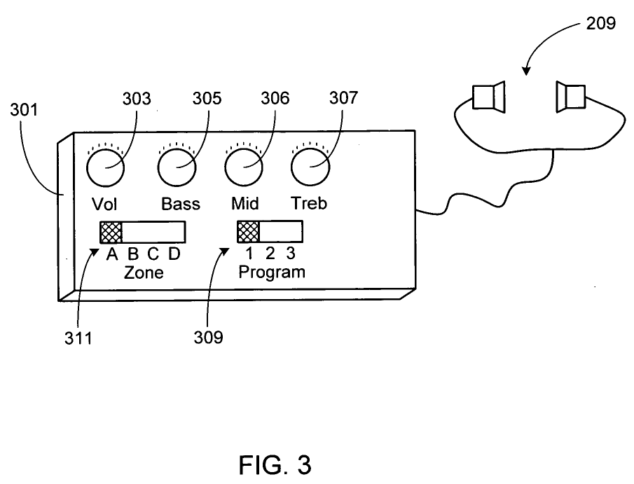

In at least one embodiment of the invention and as illustrated in FIG. 3, the wireless receiver 301 includes a volume controller 303 which allows the user to regulate the volume of the received audio program. Controller 303 can be an electro-mechanical switch (e.g., slide switch, rotating switch, etc.), an electro-optical switch (capacitive switch, resistive switch, etc.) or other switch type since the invention is not limited to a specific type of volume controller. It will be appreciated that a single venue may simultaneously offer wireless receivers with and without volume controllers; presumably those that include a volume controller would rent for a higher fee.

In at least one embodiment of the invention, the wireless receiver includes one or more controls which allow the end user to regulate, to a degree, the sound mix that they receive through audio monitors 209. In an exemplary embodiment shown in FIG. 3, the user is able to control the bass, the mid-range and the treble using controllers 305-307, respectively. It will be appreciated that a lesser or a greater amount of sound control is envisioned (i.e., a fewer or a greater number of frequency bands); that controllers 305-307 can utilize electro-mechanical, electro-optical or other switch types; that sound control and volume control are independent of one another and therefore a wireless receiver may include one, both, or neither type of audio control; and that a single venue may simultaneously offer wireless receivers with and without sound controllers. Presumably the wireless receivers that include sound control (i.e., an equalizer) would rent for a higher fee.

In at least one embodiment of the invention, the wireless receiver includes a controller 309 that allows the user to select a particular program or mix from several different programs/mixes supplied by sound processor/transmitter 203. Selection controller 309 can be an electro-mechanical switch (e.g., slide switch, rotating switch, etc.), an electro-optical switch (capacitive switch, resistive switch, etc.) or other switch type. Exemplary programs or mixes include, but are not limited to, mixes which highlight a particular instrument or artist (e.g., lead singer, drums, base, etc.) and mixes which allow the user to hear not only the musicians (i.e., primary program material) but secondary program material as well (e.g., musician comments to back-stage personnel; narration; voice overlays; etc.). It will be appreciated that a single venue may simultaneously offer wireless receivers with and without a program/mix selection controller; presumably those that include a program/mix selection controller would rent for a higher fee. Additionally, it should be understood that a program/mix selection controller is independent of volume and/or sound mix controllers.

It will be appreciated that the wireless receivers of the present invention can utilize any of a wide variety of designs, depending at least in part on the optional features included such as volume control, sound quality control, and program/mix control. For example, in at least one configuration the wireless receiver is designed to be worn by the attendee, e.g., as a belt pack or arm-band pack. In at least one other configuration, the wireless receiver is designed to be worn around the neck of the user, e.g., on a neck loop. In at least one other configuration, the wireless receiver is worn in a behind-the-ear configuration. In at least one other configuration, the wireless receiver is worn using an ear clip. It will be appreciated that these are but a few of the possible configurations that the wireless receiver can utilize.

The zone selection aspects of the present invention can be implemented in several different ways. In one embodiment, the sound processor within component 203 generates several different outputs with varying degrees of audio delay, each of which corresponds to the desired delay for a particular zone of the concert hall/arena. As a variety of techniques are well known by those of skill in the art that can be used to distinguish these signals, thereby allowing each wireless receiver to select one of these signals, further discussion of this aspect of the device is not included herein. Note that if desired and as described above, for each zone the sound processor can also generate multiple programs and/or mixes, each of which is also selectable as previously noted.

In one preferred embodiment, each wireless receiver includes a zone selection switch 311. Zone selection switch 311 can be an electro-mechanical switch (e.g., slide switch, rotating switch, etc.), an electro-optical switch (capacitive switch, resistive switch, etc.) or other switch type. Zone selection switch 311 can be designed to allow the end user, i.e., the concert attendee, to select the appropriate signal based on the zone in which the attendee is seated. Clearly the venue would insure that attendees are aware of the different zones within the hall/arena so that the end user can make the right selection. Alternately, zone selection switch 311 can be located so that it is not accessible by the user, for example by locating the switch in the battery compartment or some other ‘hidden’ location. In this configuration the venue operator would set the receiver to the appropriate zone before renting the receiver to a particular attendee.

Regardless of whether the zone selection switch 311 is intended for use by the attendee or the venue operator, there are two different techniques for utilizing the zone information by receivers 205-208. In the first technique, multiple programs/mixes are transmitted by wireless transmitter 203 and the zone selection switch is used to determine which program/mix is appropriate based on a particular receiver's zone. In the second technique, the program/mix transmitted by transmitter 203 is not delayed and each individual receiver delays the program/mix by an appropriate amount based on that receiver's zone which is given by zone selection switch 311.

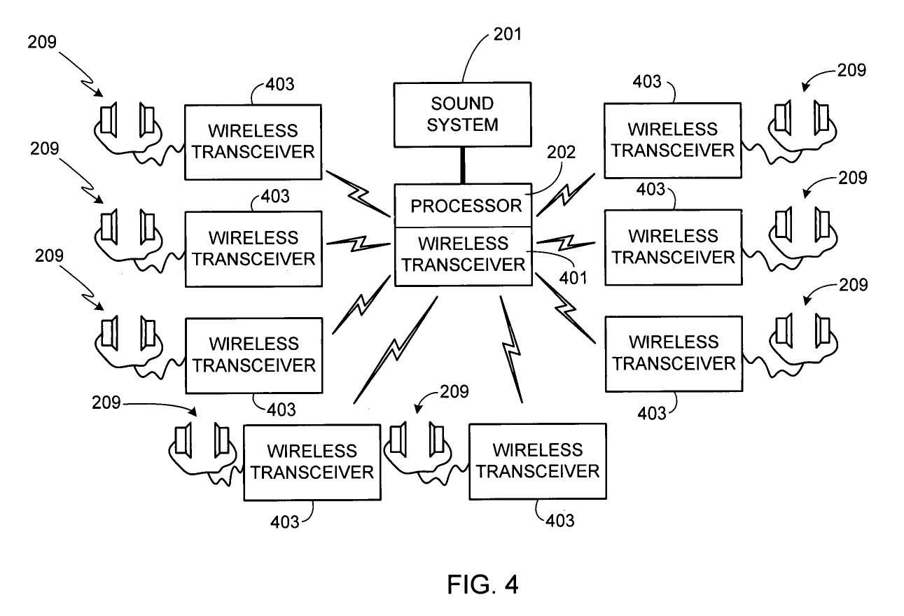

In an alternate preferred embodiment illustrated in FIG. 4, coupled to sound system 201 is a sound processor 202 and wireless transceiver 401. The system further comprises wireless transceivers 403 which are used by the participating concert attendees to receive the sound programs and mixes as previously described. However, as this system uses transceivers rather that a central transmitter and wireless receivers, the system illustrated in FIG. 4 is more versatile than the previously described embodiment.

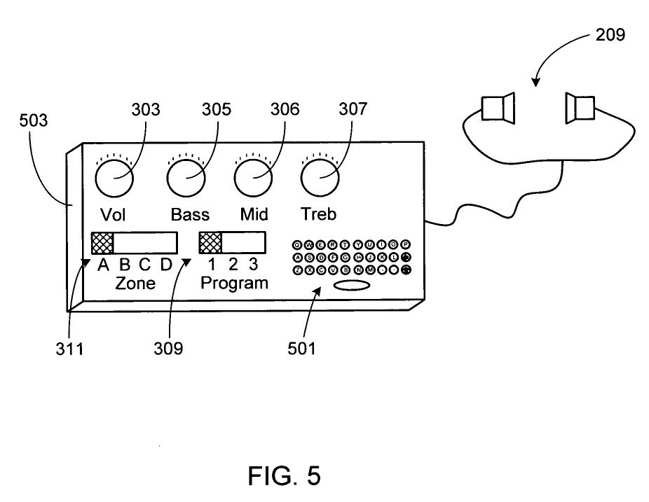

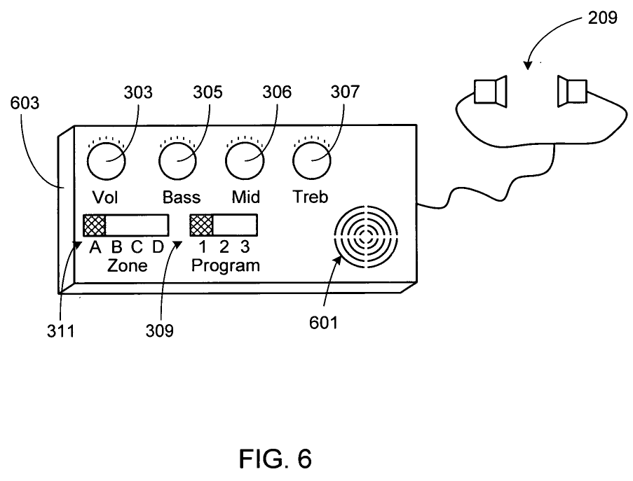

In one configuration of the system shown in FIG. 4, means are provided which allow attendees to communicate directly with the performers or back-stage personnel. The means may be a small keyboard 501 which, for example, can be mounted to the wireless transceiver as illustrated in FIG. 5. Note that keyboard 501 can be comprised of any set of keys, for example, two keys can be used which represent ‘yes’ and ‘no’, or three keys can be used which can represent three different possible choices, etc. Alternately, the attendee communication means may be a small microphone 601 which, for example, can be mounted to the wireless receiver as illustrated in FIG. 6. Note that the microphone can also be located in other locations, for example on the cable that connects audio monitors 209 to transceiver 603. It should be understood that although illustrated wireless transceivers 503 and 603 include a volume controller 303, sound controllers 305-307, program/mix selection controller 309 and zone selection switch 311, each of these features is optional and as such, may or may not be included with transceivers 503 and 603.

Although transceivers 403 can utilize zone selection means as previously described, in a preferred configuration of the system shown in FIG. 4, transceivers 403 each include a global positioning system (GPS). The inclusion of GPS in each transceiver 403 allows their position, relative to a primary location within the venue such as the stage, to be determined. Primary venue position (e.g., stage location) information can be programmed into each transceiver 403, transmitted to each transceiver 403 by central transceiver 401, or other means. By knowing its position relative to the primary venue position, transceiver 403 can automatically determine the zone in which it is located based on the distance between the primary position and the transceiver. The transceiver can then select the appropriate program/mix for its zone from the programs/mixes being transmitted by transceiver 401. Alternately, transceiver 401 can transmit a non-delayed program/mix which each transceiver 403, based on its location as determined using the GPS, can delay an appropriate amount. It will be appreciated that regardless of whether a GPS-enabled transceiver 403 selects the program/mix for its zone or calculates/implements the proper delay based on its location, the inclusion of GPS can be used to allow the transceiver to automatically change the program/mix (or delay) as the attendee using the transceiver moves about the concert hall/arena. Accordingly this implementation of the invention offers the advantage of allowing free movement of attendees while still maintaining optimal sound quality, an especially useful feature in venues with non-assigned seating.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A method of providing audio programming to a plurality of participating attendees of a live event performed at a specific venue, wherein not all attendees of the live event are participating attendees, and wherein the audio programming is provided to the participating attendees during the live event, the method comprising the steps of:
dividing the specific venue into multiple zones, wherein each particular zone of said multiple zones includes a plurality of seats;
assigning each participating attendee of said plurality of participating attendees to one of said particular zones of said multiple zones;
wirelessly transmitting the audio programming within the specific venue;
providing each participating attendee of said plurality of participating attendees a receiver, said receiver performing the steps of:
wirelessly receiving the audio programming; and
transmitting zone specific audio programming to said participating attendee through a set of audio monitors coupled to said receiver, wherein said zone specific audio programming corresponds to said particular zone assigned to said participating attendee; and
retrieving said receiver from each participating attendee after said event has concluded.

2. The method of claim 1, wherein the step of providing said receiver to each participating attendee further comprises the step of renting said receiver to each participating attendee for a rental fee, wherein said rental fee is in addition to fees paid by said participating attendee to attend the live event at the specific venue.

3. The method of claim 1, wherein the step of assigning each participating attendee to one of said particular zones further comprises the step of matching a seat assigned to said participating attendee with said one of said particular zones containing said seat.

4. The method of claim 1, wherein the step of wirelessly transmitting the audio programming further comprises the step of wirelessly transmitting a plurality of zone specific audio programming, wherein each of said plurality of zone specific audio programming corresponds to one of said particular zones of said multiple zones, and wherein said receiver further performs the step of determining which of said plurality of zone specific audio programming corresponds to said particular zone assigned to said participating attendee.

5. The method of claim 1, wherein the step of wirelessly transmitting the audio programming further comprises the step of wirelessly transmitting a plurality of zone specific audio programming, wherein each of said plurality of zone specific audio programming corresponds to one of said particular zones of said multiple zones, and wherein said receiver further performs the step of providing selection means for selecting which of said plurality of zone specific audio programming corresponds to said particular zone assigned to said participating attendee.

6. The method of claim 5, wherein the step of providing selection means for selecting which of said plurality of zone specific audio programming corresponds to said particular zone assigned to said participating attendee is performed automatically by said receiver.

7. The method of claim 5, wherein said receiver further performs the step of determining a distance between said receiver and a primary venue position corresponding to said live event, and wherein the step of providing selection means for selecting which of said plurality of zone specific audio programming corresponds to said particular zone assigned to said participating attendee is performed automatically by said receiver, said receiver using said distance between said receiver and said primary venue position.

8. The method of claim 5, wherein the step of wirelessly transmitting said plurality of zone specific audio programming further comprises the step of adding an audio delay to each of said plurality of zone specific audio programming appropriate for each particular zone.

9. The method of claim 1, wherein said receiver further performs the step of modifying said wirelessly transmitted audio programming to obtain said zone specific audio programming.

10. The method of claim 9, wherein said modifying step further comprises the step of adding an audio delay to said wirelessly transmitted audio programming for said particular zone assigned to said participating attendee.

11. The method of claim 1, further comprising the step of adding secondary program material to the audio programming, said secondary program material defining at least a portion of the audio programming, wherein said secondary program material is in addition to primary program material provided to all attendees of the live event, wherein said adding step is performed prior to said step of wirelessly transmitting the audio programming within the specific venue.

12. The method of claim 11, said receiver further performing the step of providing selection means for selecting program material to be provided as said zone specific audio programming, wherein said program material includes both said primary program material and said secondary program material.

13. The method of claim 1, said receiver further performing the step of providing a volume controller, said volume controller regulating volume of said zone specific audio programming transmitted by said receiver through said set of audio monitors.

14. The method of claim 1, said receiver further performing the step of providing at least one sound controller, said at least one sound controller regulating a sound mix corresponding to said zone specific audio programming transmitted by said receiver through said set of audio monitors.

15. The method of claim 1, said receiver further performing the step of providing means for transmitting information to a central receiver.

16. A method of providing audio programming to a plurality of participating attendees of a live event performed at a specific venue, wherein not all attendees of the live event are participating attendees, and wherein the audio programming is provided to the participating attendees during the live event, the method comprising the steps of:
dividing the specific venue into multiple zones;
wirelessly transmitting the audio programming within the specific venue, wherein said wirelessly transmitting step is performed by a central transmitter;
providing each participating attendee of said plurality of participating attendees a receiver, said receiver performing the steps of:
determining a location corresponding to said receiver relative to a primary venue location using a global positioning system integrated into said receiver, wherein said location further corresponds to a particular zone of said multiple zones;
wirelessly receiving the audio programming; and
transmitting zone specific audio programming to said participating attendee through a set of audio monitors coupled to said receiver, wherein said zone specific audio programming corresponds to said particular zone; and
retrieving said receiver from each participating attendee after said event has concluded.

17. The method of claim 16, wherein the step of providing said receiver to each participating attendee further comprises the step of renting said receiver to each participating attendee for a rental fee, wherein said rental fee is in addition to fees paid by said participating attendee to attend the live event at the specific venue.

18. The method of claim 16, wherein the step of wirelessly transmitting the audio programming further comprises the step of wirelessly transmitting a plurality of zone specific audio programming, and wherein said receiver further performs the step of determining which of said plurality of zone specific audio programming corresponds to said particular zone and said location determined by said receiver.

19. The method of claim 18, wherein said central transmitter further performs the step of adding an audio delay to each of said plurality of zone specific audio programming appropriate for each specific zone of said multiple zones.

20. The method of claim 16, wherein said central transmitter further performs the step of wirelessly transmitting within the specific venue a second location corresponding to said primary venue location, and wherein said receiver further performs the step of wirelessly receiving said second location.

21. The method of claim 16, wherein said primary venue location is preprogrammed into said receiver.

22. The method of claim 16, wherein said receiver further performs the step of modifying said wirelessly transmitted audio programming to obtain said zone specific audio programming.

23. The method of claim 22, wherein said modifying step further comprises the step of adding an audio delay to said wirelessly transmitted audio programming for said particular zone and said location determined by said receiver.

24. The method of claim 16, further comprising the step of adding secondary program material to the audio programming, said secondary program material defining at least a portion of the audio programming, wherein said secondary program material is in addition to primary program material provided to all attendees of the live event, wherein said adding step is performed prior to said step of wirelessly transmitting the audio programming within the specific venue.

25. The method of claim 24, said receiver further performing the step of providing selection means for selecting program material to be provided as said zone specific audio programming, wherein said program material includes both said primary program material and said secondary program material.

26. The method of claim 16, said receiver further performing the step of providing a volume controller, said volume controller regulating volume of said zone specific audio programming transmitted by said receiver through said set of audio monitors.

27. The method of claim 16, said receiver further performing the step of providing at least one sound controller, said at least one sound controller regulating a sound mix corresponding to said zone specific audio programming transmitted by said receiver through said set of audio monitors.

28. The method of claim 16, said receiver further performing the step of providing means for transmitting information to said central transmitter.

29. A venue network system comprising:
a central processor, said central processor receiving an audio mix of a live event performed within a specific venue, wherein said specific venue is divided into multiple zones;
a central transmitter coupled to said central processor, said central transmitter wirelessly transmitting an audio program within said specific venue, said audio program comprising at least a portion of said audio mix; and
a plurality of receivers configured to receive said audio program, wherein each of said plurality of receivers is configured for a particular zone of said multiple zones, wherein each of said plurality of receivers further comprises a processor and a pair of audio monitors, wherein said processor processes said audio program to generate a zone specific audio program and to transmit said zone specific audio program through said pair of audio monitors, wherein said zone specific audio program corresponds to said particular zone of said multiple zones.

30. The venue network system of claim 29, wherein each of said plurality of receivers further comprises a global positioning system, wherein said processor determines said particular zone of said multiple zones from receiver location information provided by said global positioning system.

31. The venue network system of claim 29, wherein each of said plurality of receivers further comprises a zone selector for identifying said particular zone of said multiple zones.

32. The venue network system of claim 29, said central processor receiving secondary program material that is in addition to primary program material provided to all attendees of the live event, said secondary program material defining at least a portion of the audio program.

33. The venue network system of claim 29, wherein each of said plurality of receivers further comprises a volume controller, said volume controller regulating volume of said zone specific audio program transmitted through said pair of audio monitors.

34. The venue network system of claim 29, wherein each of said plurality of receivers further comprises at least one sound controller, said at least one sound controller regulating a sound mix corresponding to said zone specific audio program transmitted through said pair of audio monitors.

35. The venue network system of claim 29, wherein each of said plurality of receivers further comprises means for transmitting information to said central processor.

36. The venue network system of claim 35, wherein said transmitting means is a keypad.

37. The venue network system of claim 35, wherein said transmitting means is a microphone.

38. A venue network system comprising:
a central processor, said central processor receiving an audio mix of a live event performed within a specific venue, wherein said specific venue is divided into multiple zones;
a central transmitter coupled to said central processor, said central transmitter wirelessly transmitting a plurality of zone specific audio programs within said specific venue, wherein each of said plurality of zone specific audio programs comprise at least a portion of said audio mix; and
a plurality of receivers, wherein each particular receiver of said plurality of receivers is configured to receive a particular zone specific audio program corresponding to a particular zone assigned to said particular receiver, wherein each particular receiver of said plurality of receivers further comprises a processor and a pair of audio monitors, wherein said processor processes said particular zone specific audio program and transmits said zone particular zone specific audio program through said pair of audio monitors.

39. The venue network system of claim 38, said central processor receiving secondary program material that is in addition to primary program material provided to all attendees of the live event, said secondary program material defining at least a portion of each of said plurality of zone specific audio programs.

40. The venue network system of claim 38, wherein each particular receiver of said plurality of receivers further comprises a volume controller, said volume controller regulating volume of said particular zone specific audio program transmitted through said pair of audio monitors.

41. The venue network system of claim 38, wherein each particular receiver of said plurality of receivers further comprises at least one sound controller, said at least one sound controller regulating a sound mix corresponding to said particular zone specific audio program transmitted through said pair of audio monitors.

42. The venue network system of claim 38, wherein each particular receiver of said plurality of receivers further comprises means for transmitting information to said central processor.

43. The venue network system of claim 42, wherein said transmitting means is a keypad.

44. The venue network system of claim 42, wherein said transmitting means is a microphone.
